(19) United States
(12) Patent Application Publication
(10) Pub. No.: US 2009/0189839 A1
(43) Pub. Date: Jul. 30, 2009

(54) LIQUID CRYSTAL DISPLAY

(76) Inventors: GWANG BUM KO, Asan-si (KR); Byoung-Sun Na, Hwaseong-si (KR); Won-Hee Lee, Seoul (KR); Ho-Kyoon Kwon, Seoul (KR); Soon-Il Ahn, Cheonan-si (KR); Ji-Hyun Kwon, Asan-si (KR); Hye-Seok Na, Seoul (KR)

Correspondence Address: Frank Chau, Esq.;F. CHAU & ASSOCIATES, LLC, 130 Woodbury Road, Woodbury, NY, 11797, US

(21) Appl. No.: 12/326,471

(22) Filed: Dec. 2, 2008

(30) Foreign Application Priority Data
Jan. 28, 2008 (KR) 2008-08686

(51) Int. Cl. G09G 3/36

(52) U.S. Cl. 345/87

(57) ABSTRACT

A liquid crystal display including a liquid crystal display panel having a display area that displays an image in response to a gate signal and a data signal, and a peripheral area including first, second, third and fourth peripheral areas surrounding the display area; a plurality of gate drivers performing a scanning operating in response to a first control signal to output the gate signal, the gate drivers being arranged in the first peripheral area; a plurality of data drivers arranged in the second peripheral area adjacent to a gate driver that last performs the scanning operating among the gate drivers; and a signal transmission line connected to a gate driver that first performs the scanning operation among the gate drivers, and routed through the third and fourth peripheral areas opposite to the first and second peripheral areas, respectively, to provide the first control signal to the gate drivers.

### CROSS-REFERENCE TO RELATED APPLICATION

This application is based on and claims priority from Korean Patent Application No. 2008-08686 filed on Jan. 28, 2008, the contents of which are herein incorporated by reference in its entirety.

### BACKGROUND OF THE INVENTION

1. Technical Field

The present disclosure relates to a liquid crystal display. More particularly, the present disclosure relates to a liquid crystal display with improved display quality.

2. Discussion of the Related Art

Among flat panel displays, liquid crystal displays have various advantages such as small thickness, light weight, and low power consumption, etc. Liquid crystal displays include a liquid crystal display panel including a display area in which an image is displayed and a peripheral area surrounding the display area, driving chips driving the liquid crystal display panel in response to driving signals, and a timing controller applying the driving signals to the driving chips through signal transmission lines.

The liquid crystal display panel displays the image in response to gate signals and data signals. The driving chips include gate drivers and data drivers. The gate drivers apply the gate signals to the liquid crystal display panel, and the data drivers apply the data signals to the liquid crystal display panel.

In order to reduce the manufacturing cost of the liquid crystal display, line design rules mandate that signal transmission lines for transmitting various signals, such as driving signals, control signals, etc., be arranged in the peripheral area adjacent to the gate drivers.

This results in signal transmission lines arranged at high density in the peripheral area adjacent to the gate drivers. Since the peripheral area is small compared with the whole area of the liquid crystal display panel, the signal transmission lines are arranged at high density in a narrow gap, resulting in narrow signal transmission lines. Accordingly, the line resistance of the signal transmission lines increases, thereby distorting the various signals being transmitted therethrough.

When a gate-on voltage is distorted, the pixels have different charge rates according to corresponding gate drivers causing a gate block phenomenon where blocks having different brightness from each other appear on the liquid crystal display.

### SUMMARY OF THE INVENTION

Exemplary embodiments of the present invention seek to provide a liquid crystal display capable of preventing display defects.

A liquid crystal display, according to an exemplary embodiment of the present invention, includes a liquid crystal display panel, a plurality of gate drivers, a plurality of data drivers, and a signal transmission line.

The liquid crystal display panel includes a display area that displays an image in response to a gate signal and a data signal, and a peripheral area including first, second, third and fourth peripheral areas surrounding the display area.

The gate drivers are arranged in the first peripheral area. The gate drivers perform a scanning operation along a predetermined direction in response to a first control signal to output the gate signal.

The data drivers are arranged in the second peripheral area to output the data signal in response to a second control signal, and the second peripheral area is defined adjacent to a gate driver that last performs the scanning operation among the gate drivers.

The signal transmission line is connected to a gate driver that first performs the scanning operation among the gate drivers, and routed through the third and fourth peripheral areas opposite to the first and second peripheral areas, respectively, to provide the first control signal to the gate drivers.

According to the above, the signal transmission line that transmits the first control signal is connected to the gate drivers after being extended through the third and fourth peripheral areas of which the line density is lower than that of the first peripheral area. Thus, the signal transmission line arranged in the first peripheral area may be wider. Further, a width of the signal transmission line arranged in the third and fourth peripheral areas may be wider since the line density of the third and fourth peripheral areas is lower than that of the first peripheral area. Accordingly, the liquid crystal display may be prevented from displaying defects caused by signal distortions of the various signals applied to the gate driving circuit.

### BRIEF DESCRIPTION OF THE DRAWINGS

Exemplary embodiments of the present invention will become apparent by reference to the following detailed description when considered in conjunction with the accompanying drawings, wherein:

FIG. 1 is a block diagram showing a liquid crystal display according to an exemplary embodiment of the present invention;

FIG. 2 is a perspective view showing a structure of the liquid crystal display of FIG. 1;

FIG. 3 is a plan view showing the liquid crystal display of FIG. 2;

FIG. 4 is a plan view showing a signal transmission line arranged on a liquid crystal display panel of FIG. 2; and

FIG. 5 is a plan view showing a liquid crystal display according to an exemplary embodiment of the present invention.

### DETAILED DESCRIPTION OF EXEMPLARY EMBODIMENTS

It will be understood that when an element or layer is referred to as being “on”, “connected to” or “coupled to” another element or layer, it can be directly on, connected or coupled to the other element or layer or intervening elements or layers may be present. Like numbers refer to like elements throughout.

In the exemplary embodiments of the present invention, gate drivers and/or data drivers may be attached to a liquid crystal display panel by a tape automated-bonding (TAB) method, such as a tape carrier package (TCP), a chip on film (COF) method, etc. The gate drivers and/or the data drivers may be mounted on the liquid crystal display panel by a chip on glass (COG) method.

Also, an amorphous silicon gate driving circuit may be integrated into the liquid crystal display panel.

Further, a direction where a data signal is applied to the liquid crystal display panel is opposite to a scanning direction of the gate drivers. This may be adapted to a notebook computer system.

Hereinafter, embodiments of the present invention will be explained in detail with reference to the accompanying drawings.

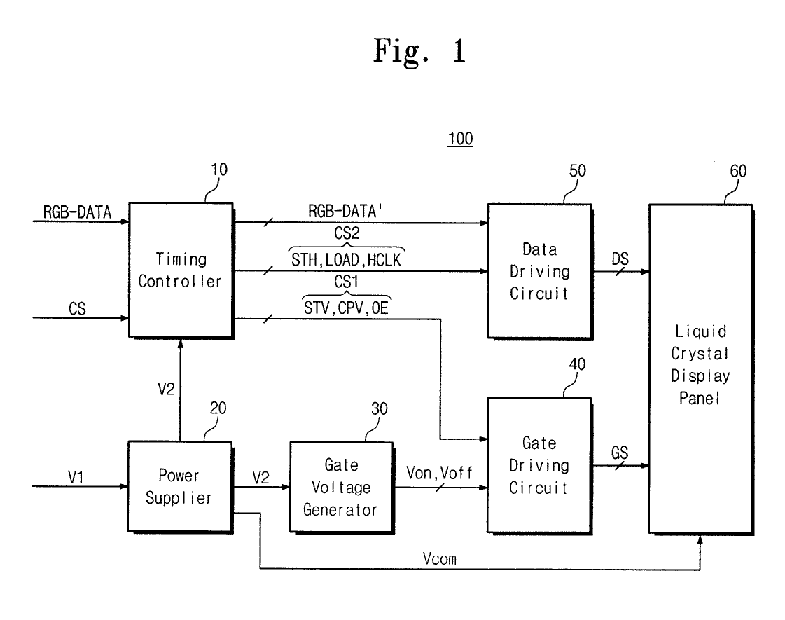

FIG. 1 is a block diagram showing a liquid crystal display according to an exemplary embodiment of the present invention.

Referring to FIG. 1, a liquid crystal display 100 includes a timing controller 10, a power supplier 20, a gate voltage generator 30, a gate driving circuit 40, a data driving circuit 50, and a liquid crystal display panel 60.

The timing controller 10 receives an image signal RGB-DATA including red, green, and blue, and a control signal CS controlling an output timing of the image signal RGB-DATA. The timing controller 10 converts the image signal RGB-DATA into an image signal RGB-DATA′ of which the output timing is controlled by the control signal CS and outputs the image data RGB-DATA′. The image signal RGB-DATA is input to the data driving circuit 50. The timing controller 10 generates a first control signal CS1 and a second control signal CS2 in response to the control signal CS. The first control signal CS1 is applied to the gate driving circuit 40 and the second control signal CS2 is applied to the data driving circuit 50.

The power supplier 20 receives an external power voltage V1 to generate a constant voltage V2, for operation of the gate voltage generator 30, and a common voltage Vcom. The constant voltage V2 is applied to the timing controller 10 and the gate voltage generator 30, and the common voltage Vcom is applied to the liquid crystal display panel 60.

The gate voltage generator 30 generates a gate voltage signal including a gate-on voltage Von and a gate-off voltage Voff. The gate-on voltage Von and the gate-off voltage Voff are applied to the gate driving circuit 40.

The gate driving circuit 40 applies the gate-on voltage Von and the gate-off voltage Voff to the liquid crystal display panel 60 in response to the first control signal CS1 from the timing controller 10. When the gate-on voltage Von and the gate-off voltage Voff are sequentially applied to the liquid crystal display panel 60, a scanning operation of the gate driving circuit 40 may be performed. The first control signal CS1 includes a gate clock signal CPV that controls the output of the gate voltage signal Von and Voff, a scan start signal STV that indicates a start of the scanning operation, and an output enable signal OE that determines a maintenance time of gate signals GS. The maintenance time of the gate signals GS represents a maintenance time of the gate-on voltage Von and a maintenance time of the gate-off voltage Voff.

The data driving circuit 50 outputs data signals DS in response to the second control signal CS2 and the image signal RGB-DATA′ from the timing controller 10. The second control signal CS2 includes a horizontal start signal STH that indicates a start of transmission of the data signals DS, a load signal LOAD that indicates the output of the data signals DS from the data driving circuit 50, and a data clock signal HCLK. Also, the second control signal CS2 may further include a reversal signal RVS that reverses a voltage polarity of the data signals DS with reference to the common voltage Vcom.

The liquid crystal display panel 60 displays a desired image in response to the data signals DS and the gate signals GS.

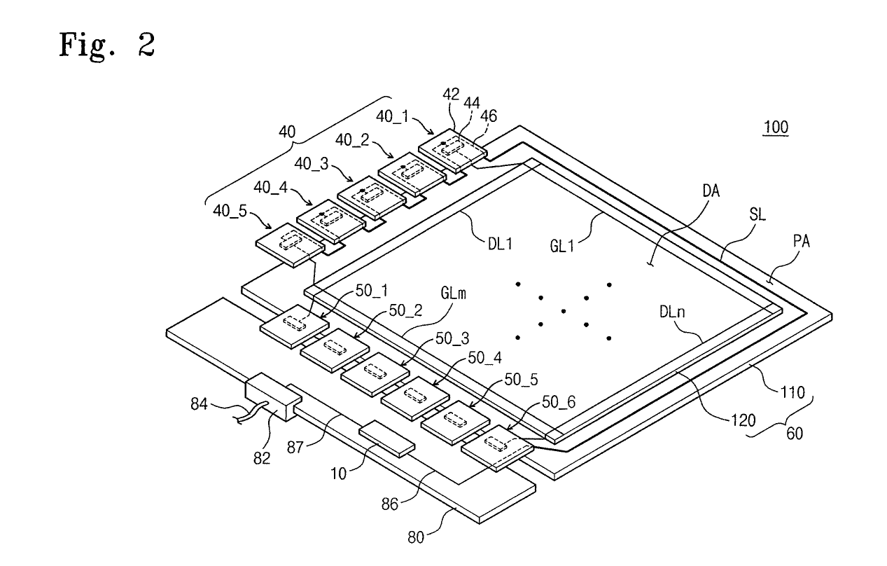

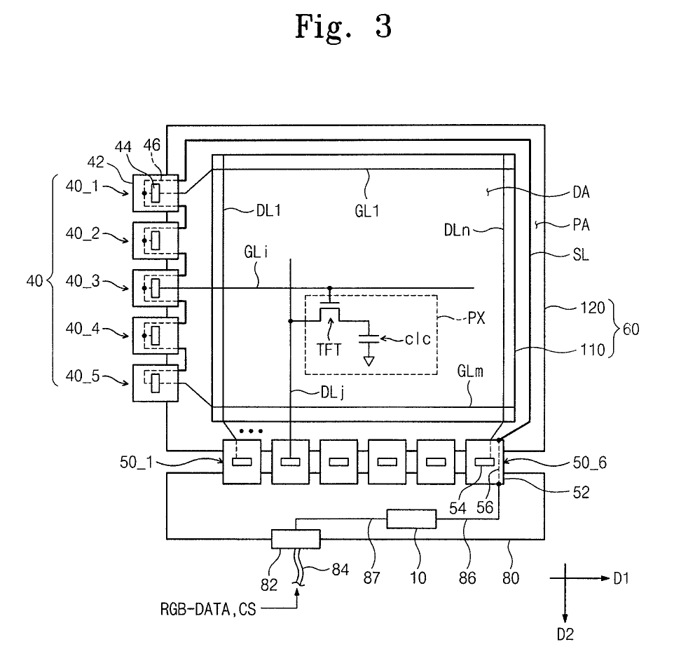

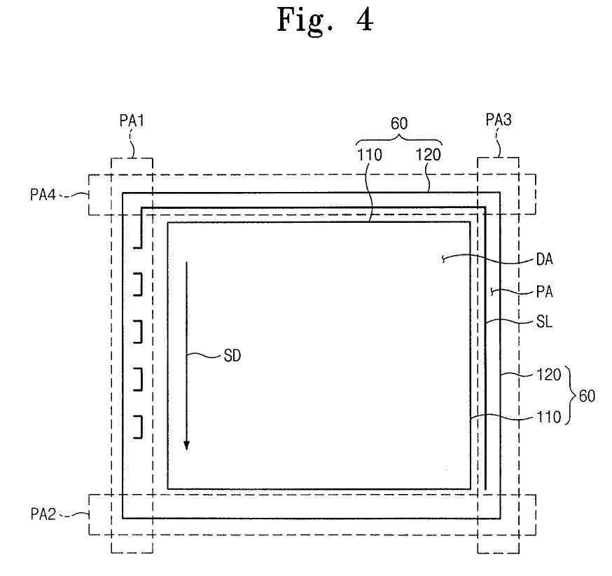

FIG. 2 is a perspective view showing a structure of the liquid crystal display of FIG. 1, FIG. 3 is a plan view showing the liquid crystal display of FIG. 2, and FIG. 4 is a plan view showing a signal transmission line arranged on the liquid crystal display panel of FIG. 2. For explanation purposes, five gate drivers 40-1˜40-5 and six data drivers 50-1˜50-6 are shown in FIGS. 2 and 3. Further, only one signal transmission line is shown in FIGS. 2 and 3, but a plurality of signal transmission lines may be arranged on the liquid crystal display panel. Since the signal transmission lines have the same configuration and function, one signal transmission line will be described as a representative example of the signal transmission lines.

Referring to FIGS. 2 and 3, the liquid crystal display 100 includes the liquid crystal display panel 60, the gate driving circuit 40 including a plurality of gate drivers 40-1˜40-5, the data driving circuit 50 including a plurality of data drivers 50-1˜50-6, and a signal transmission line SL transmitting the first control signal CS1. The liquid crystal display 100 further includes a printed circuit board 80 and the timing controller 10 mounted on the printed circuit board 80.

The liquid crystal display panel 60 includes a thin film array substrate 110, a color filter substrate 120, and a liquid crystal layer (not shown) interposed between the thin film array substrate 110 and the color filter substrate 120.

The thin film array substrate 110 is divided into a display area DA on which an image is displayed and a peripheral area PA surrounding the display area DA.

The thin film array substrate 110 includes a plurality of gate lines GL1˜GLm, a plurality of data lines DL1˜DLn, and a plurality of pixel areas defined by the gate lines GL1˜GLm and the data lines DL1˜DLn. The gate lines GL1˜GLm, the data lines DL1˜DLn, and the pixel areas are arranged in the display area DA.

The gate lines GL1˜GLm are extended in a first direction D1 and arranged along a second direction D2 substantially perpendicular to the first direction D1 in order to receive the gate signals GS from the gate drivers 40-1˜40-5. Particularly, the gate signals GS are sequentially applied to the gate lines GL1˜GLm in the order from a first gate line GL1 to a last gate line GLm, and thus a scanning operation of the gate drivers 40-1˜40-5 advances in the second direction D2 (i.e., a direction from the first gate line GL1 to the last gate line GLm). The data lines DL1˜DLn are extended in the second direction D2 and arranged along the first direction D1 in order to substantially simultaneously receive the data signals DS. Since the data drivers 50-1˜50-6 are arranged adjacent to the last gate line GLm, the data signals DS are applied to pixels connected to the gate lines GL1˜GLm and advance in a direction opposite to the second direction D2 (i.e., a direction from the pixels connected to the last gate line GLm to pixels connected to the first gate line GL1). That is, a scanning direction SD (refer to FIG. 4) of the gate drivers 40-1˜40-5 and an advancing direction of the data signals DS applied to the pixels are opposite to each other. Although not shown in FIGS. 2 and 3, the gate lines GL1˜GLm are electrically insulated from and intersected with the data lines DL1˜DLn.

Arranged in each pixel area are a thin film transistor TFT electrically connected to a corresponding data line DLj of the data lines DL1˜DLn and to a corresponding gate line GLi of the gate lines GL1˜GLm, and a pixel electrode (not shown) receiving a corresponding data signal of the data signals DA through the thin film transistor TFT.

The signal transmission line SL is arranged in the peripheral area PA of the thin film array substrate 110 in order to transmit the first control signal CS1 that controls the gate drivers 40-1˜40-5. The gate drivers 40-1˜40-5 are connected to one end of the peripheral area PA of the thin film array substrate 110, and the data drivers 50-1˜50-6 are connected to another adjacent end of the peripheral area PA.

Referring to FIG. 4, the peripheral area PA of the thin film array substrate 110 includes a first peripheral area PA1, a second peripheral area PA2, a third peripheral area PA3, and a fourth peripheral area PA4.

The gate drivers 40-1˜40-5 may be electrically connected to the first peripheral area PA1 by a tape-automated bonding (TAB) method. The data drivers 50-1˜50-6 may be electrically connected to the second peripheral area PA2 adjacent to the first peripheral area PA1 by the TAB method.

The signal transmission line SL is arranged along the third and fourth peripheral areas PA3 and PA4 that are opposite to the first and second peripheral areas PA1 and PA2, respectively. Accordingly, the signal transmission line SL is extended in the same direction as the data lines DL1˜DLn in the third peripheral area PA3 and extended in the same direction as the gate lines GL1˜GLm in the fourth peripheral area PA4. Also, the signal transmission line SL is arranged in the first peripheral area PA1, but the signal transmission line SL arranged in the first peripheral area PA1 is partially disconnected according to the gate drivers 40-1˜40-5.

That is, the gate drivers 40-1˜40-5 attached to the first peripheral area PA1 are electrically connected to each other by the signal transmission line SL arranged in the peripheral area PA1. Thus, the gate drivers 40-1˜40-5 may receive the first control signal CS1 through the signal transmission line SL.

Meanwhile, although not shown in FIG. 4 in detail, since the first control signal CS1 includes the gate clock signal CPV, the scan start signal STV, and the output enable signal OE, the signal transmission line SL may include a first driving line through which the gate clock signal CPV is transmitted, a second driving line through which the scan start signal STV is transmitted, and a third driving line through which the output enable signal OE is transmitted.

Referring to FIG. 2 again, the color filter substrate 120 includes a color filter layer (not shown) and a common electrode (not shown). The color filter layer includes red, green, and blue color pixels. The common electrode receives the common voltage and faces the pixel electrode arranged on the thin film array substrate 110 while interposing the liquid crystal layer (not shown) therebetween. Therefore, the pixel electrode, the common electrode, and the liquid crystal layer may form a liquid crystal capacitor Clc as shown in FIG. 3.

Each of the gate drivers 40-1˜40-5 includes a flexible printed circuit board 42, a gate driving integrated circuit (IC) 44, and a flexible line 46. The flexible printed circuit board 42 is attached to the first peripheral area PA1. The gate driving IC 44 may be mounted on the flexible printed circuit board 42 by a flip-chip bumping method. The flexible line 46 is electrically connected to the gate drivers 44 to electrically connect the signal transmission line SL to each other. The gate driving IC 44 included in a first gate driver 40-1 of the gate drivers 40-1˜40-5 first receives the scan start signal STV of the first control signal CS1. Thus, either the gate-on voltage or the gate-off voltage is first applied to the first gate line GL1 of the gate lines GL1˜GLn as the gate signal GS.

The data drivers 50-1˜50-6 may be attached to the second peripheral area PA2 adjacent to the first peripheral area PA1 by the TAB method. Each of the data drivers 50-1˜50-6 includes a flexible printed circuit substrate 52 and a data driving IC 54. The data driving IC 54 may be mounted on the flexible printed circuit board 52 by the flip-chip bumping method. The flexible printed circuit board 52 for a sixth data driver 50-6 of the data drivers 50-1˜50-6, which is farthest from the gate drivers 40-1˜40-5, further includes a flexible line 56 that is electrically connected to the signal transmission line SL arranged in the third peripheral area PA3. Accordingly, the first control signal CS1 may be applied to the signal transmission line SL through the flexible line 56.

The liquid crystal display 100 further includes the printed circuit board 80 and the timing controller 10.

The flexible printed circuit boards 52 of the data drivers 50-1˜50-6 may be connected to the printed circuit board 80 by the TAB method. That is, the flexible printed circuit boards 52 of the data drivers 50-1˜50-6 are connected between the printed circuit board 80 and the second peripheral area PA2 of the liquid crystal display panel 100. The timing controller 10 is mounted on the printed circuit board 80. The timing controller 10 is electrically connected to the flexible line 56 arranged on the sixth data driver 50-6 through a first connection line 86 arranged on the printed circuit board 80. Thus, the signal transmission line SL may receive the first control signal CS1 through the sixth data driver 50-6.

Also, a connector 82 and a cable 84 connected to the connector 82 are arranged on the printed circuit board 80. The connector 82 is electrically connected to the timing controller 10 through a second connection line 87 arranged on the printed circuit board 80. The connector 82 receives the image signal RGB-DATA and the control signal CS from an external system (e.g., graphic controller) through the cable 84.

As described above, in the liquid crystal display 100 according to an exemplary embodiment of the present invention, the signal transmission line SL that transmits the first control signal CS1 is arranged via the third and fourth peripheral areas PA3 and PA4 and electrically connected to the gate drivers 40-1˜40-5.

Although not shown in the figures, signal transmission lines for transmission of the gate-on voltage Von, the gate-off voltage Voff, the power voltage V1, and the common voltage Vcom are arranged in the first peripheral area PA1. However, the signal transmission line SL for transmission of the first control signal CS1 including the scan start signal SPV, the output enable signal OE, and the gate clock signal CPV is connected to the gate drivers 40-1˜40-5 after being extended through the third and fourth peripheral areas PA3 and PA4 of which a line density is lower than that of the first peripheral area PA1.

Since the signal transmission line SL that transmits the first control signal CS1 including the scan start signal SPV, the output enable signal OE, and the gate clock signal CPV are arranged in the third and fourth peripheral areas PA3 and PA4, the first peripheral area PA1 may have a space sufficient to expand the width of the signal transmission lines for the gate-on voltage Von, the gate-off voltage Voff, the power voltage V1, and the common voltage Vcom.

In addition, although the length and the line resistance of the signal transmission line SL increases due to the extension of the signal transmission line SL, the line resistance may be sufficiently offset by expanding the width of the signal transmission line SL arranged in the third and fourth peripheral areas PA3 and PA4 of which the line density is lower than that of the first peripheral area PA1.

Table 1 represents simulated results of resistance for various lines in a conventional signal transmission line structure, and Table 2 represents simulated results of resistance for various lines in the signal transmission line structure according to an exemplary embodiment of the present invention.

TABLE 1

| | D-G1 | G1-G2 | G2-G3 | G3-G4 | Total (Ω) |
|---|---|---|---|---|---|
| Vcom line | 34.6 | 91.9 | 95.0 | 97.1 | 318.6 |
| OE line | 122.7 | 134.5 | 140.8 | 152.1 | 550.1 |
| CPV line | 122.8 | 131.2 | 142.9 | 155.7 | 552.6 |
| GND line | 93.6 | 79.7 | 84.0 | 105.0 | 362.3 |
| V1 line | 61.5 | 62.8 | 65.2 | 69.1 | 258.6 |
| STV line | 105.1 | 240.9 | 251.8 | 262.4 | 860.2 |
| Voff line | 20.5 | 21.5 | 21.0 | 25.7 | 88.7 |
| Von line | 34.6 | 31.8 | 32.2 | 33.8 | 132.4 |

TABLE 2

| | D-G1 | G1-G2 | G2-G3 | G3-G4 | Total (Ω) |
|---|---|---|---|---|---|
| Vcom line | 31.6 | 76.6 | 79.2 | 80.9 | 268.3 |
| OE line | 117.5 | 129.6 | 134.0 | 144.0 | 524.8 |
| CPV line | 118.5 | 125.1 | 130.6 | 141.1 | 515.3 |
| GND line | 80.6 | 64.3 | 67.6 | 82.8 | 295.3 |
| V1 line | 60.5 | 50.6 | 53.2 | 57.8 | 222.1 |
| STV line | 372.8 | 120.3 | 124.8 | 130.2 | 748.2 |
| Voff line | 18.5 | 17.9 | 17.5 | 21.4 | 75.3 |
| Von line | 29.1 | 27.4 | 28.2 | 32.5 | 117.2 |

In Tables 1 and 2, the left column represents the lines that are connected to the gate drivers and the upper row represents resistances between the data driver and the gate driver or between the gate drivers. In particular, D-G1 represents the resistance of each line arranged between the first data driver 50-1 and the fifth gate driver 40-5, G1-G2 represents the resistance of each line arranged between the fifth gate driver 40-5 and the fourth gate driver 40-4, G2-G3 represents the resistance of each line arranged between the fourth gate driver 40-4 and the third gate driver 40-3, G3-G4 represents the resistance of each line arranged between the third gate driver 40-3 and the second gate driver 40-2.

Also, Table 1 represents the resistance of each line that is designed to have a width of about 50 micrometers to about 60 micrometers, and Table 2 represents the resistance of each line that is designed to have a width of about 300 micrometers to about 700 micrometers.

As shown in FIG. 2, the total amount of the resistances of the lines according to the present exemplary line structure is reduced by about 10% compared with the total amount of the resistances of the lines according to the conventional structure.

Further, in spite of the increase of the length of the lines, since the width of each signal transmission line for the scan start signal STV, the output enable signal OE, and the gate clock signal CPV is wider, the total amount of the resistances of the lines according to the present exemplary line structure may be reduced.

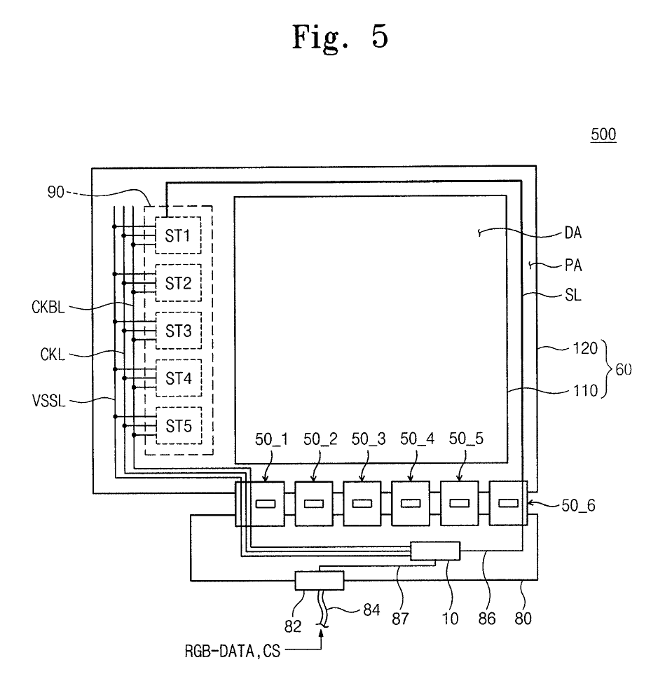

FIG. 5 is a plan view showing a liquid crystal display according to an exemplary embodiment of the present invention.

Referring to FIG. 5, a liquid crystal display 500 includes a liquid crystal display panel 60, a gate driving circuit 90, a data driving circuit 50 including a plurality of data drivers 50-1˜50-6, and a signal transmission line SL transmitting a scan start signal STV. Also, the liquid crystal display 500 further includes a printed circuit board 80 and a timing controller 10 mounted on the printed circuit board 80.

The liquid crystal display 500 shown in FIG. 5 has the same circuit configurations and functions as those of the liquid crystal display 100 shown in FIGS. 2 to 4 except that the gate driving circuit 90 is directly formed on the liquid crystal display panel 60 using amorphous silicon gate (ASG). Thus, the detailed descriptions of the liquid crystal display panel 60, the data drivers 50-1˜50-6, the signal transmission line SL, the printed circuit board 80, and the timing controller 10 will be omitted.

The gate driving circuit 90 shown in FIG. 5 is directly formed on the liquid crystal display panel 60 through the same thin film forming process that is applied to form pixels on the liquid crystal display panel 60. Also, the gate driving circuit 90 includes plural stages connected to each other, but for explanation purposes, a gate driving circuit 90 including five stages ST1˜ST5 is shown in FIG. 5. Each of the stages ST1˜ST5 is electrically connected to a voltage line VSSL transmitting a ground voltage, a first clock line CLKL transmitting a first clock, and a second clock line CLKBL transmitting a second clock having an opposite phase to the first clock.

Meanwhile, in FIGS. 2 to 4, the first control signal CS1 for the gate driving circuit 40 includes the scan start signal STV, the output enable signal OE, and the gate clock signal CPV. However, as shown in FIG. 5, when the gate driving circuit 90 includes plural stages ST1˜ST5, the output enable signal OE and the gate clock signal CPV are not required. Accordingly, the signal transmission line SL transmits only the scan start signal STV.

According to the above, the signal transmission line that transmits the first control signal is connected to the gate drivers after being extended through the third and fourth peripheral areas PA3 and PA4 of which the line density is lower than that of the first peripheral area PA1. Thus, the signal transmission line arranged in the first peripheral area may be wider.

Further, the width of the signal transmission line arranged in the third and fourth peripheral areas may be wider since the line density of the third and fourth peripheral areas PA3 and PA4 is lower than that of the first peripheral area PA1. Accordingly, the liquid crystal display may be prevented from displaying defects caused by signal distortions of the various signals applied to the gate driving circuit.

Although exemplary embodiments of the present invention have been described, it is to be understood that the present invention should not be limited to these exemplary embodiments but various changes and modifications may be made by one of ordinary skilled in the art within the spirit and scope of the disclosure.

What is claimed is:

1. A liquid crystal display comprising:
a liquid crystal display panel including a display area that displays an image in response to a gate signal and a data signal, and a peripheral area including first, second, third and fourth peripheral areas surrounding the display area;
a plurality of gate drivers performing a scanning operation along a predetermined direction in response to a first control signal to output the gate signal, the gate drivers being arranged in the first peripheral area;
a plurality of data drivers arranged in the second peripheral area to output the data signal in response to a second control signal, the second peripheral area being adjacent to a gate driver that last performs the scanning operation among the gate drivers; and
a signal transmission line connected to a gate driver that first performs the scanning operation among the gate drivers, and routed through the third and fourth peripheral areas opposite to the first and second peripheral areas, respectively, to provide the first control signal to the gate drivers.

2. The liquid crystal display of claim 1, wherein the signal transmission line receives the first control signal from a data driver that is farthest from the gate drivers.

3. The liquid crystal display of claim 2, wherein each of the data drivers comprises:
a flexible printed circuit board connected to the second peripheral area of the liquid crystal display panel; and
a data driving chip mounted on the flexible printed circuit board to apply the data signal to the liquid crystal display panel, and
wherein the data driver that is farthest from the gate drivers further comprises a flexible line arranged on the flexible printed circuit board and electrically connected to the signal transmission line to transmit the first control signal to the signal transmission line.

4. The liquid crystal display of claim 3, further comprising:
a printed circuit board electrically connected to the flexible printed circuit board; and
a timing controller mounted on the printed circuit board to generate the first control signal and the second control signal, and
wherein the timing controller is electrically connected to the flexible line through a line arranged on the printed circuit board.

5. The liquid crystal display of claim 1, wherein the first control signal comprises a scan start signal that indicates a start of the gate signal, a gate clock signal that controls an output timing of the gate signal, and an output enable signal that determines a maintenance time of the gate signal.

6. The liquid crystal display of claim 5, wherein the gate drivers sequentially output the gate signal in response to the scan start signal, and the gate signal is sequentially applied to the gate drivers starting from a gate driver that is farthest from the data drivers to a gate driver that is closest to the data drivers.

7. The liquid crystal display of claim 5, wherein the signal transmission line comprises:
a first signal transmission line that transmits the scan start signal;
a second signal transmission line that transmits the gate clock signal; and
a third signal transmission line that transmits the output enable signal.

8. The liquid crystal display of claim 7, wherein each of the first, second, and third signal transmission lines has a width of about 50 micrometers to about 60 micrometers.

9. The liquid crystal display of claim 1, wherein the gate drivers are mounted on the liquid crystal display panel by a chip-on-glass method.

10. The liquid crystal display of claim 1, wherein the gate drivers are mounted on the liquid crystal display panel by a tape automated-bonding method.

11. The liquid crystal display of claim 1, wherein the gate drivers are directly formed on the liquid crystal display panel using an amorphous silicon gate.

12. The liquid crystal display of claim 11, wherein the first control signal comprises a scan start signal of the gate drivers.

13. The liquid crystal display of claim 12, wherein the signal transmission line transmits the scan start signal.

14. A liquid crystal display comprising:
a liquid crystal display panel including a display area that displays an image in response to a gate signal and a data signal, and a peripheral area including first, second, third and fourth areas surrounding the display area;
a plurality of gate drivers performing a scanning operation in response to a first control signal to output the gate signal, the gate drivers being arranged in the first peripheral area;
a plurality of data drivers arranged in the second peripheral area forming a right angle with the first peripheral area; and
a signal transmission line connected to a gate driver closest to an intersection between the first and fourth peripheral areas, and routed through the third and fourth peripheral areas to provide the first control signal to the gate drivers in the first peripheral area.

15. The liquid crystal display of claim 14, wherein the signal transmission line receives the first control signal from a data driver that is closest to an intersection between the second and third peripheral areas.

16. The liquid crystal display of claim 15, where a width of the signal transmission line is in a range of 50 to 60 micrometers.

17. The liquid crystal display of claim 15, wherein the signal transmission line comprises a plurality of signal transmission lines.
